(19) United States
(12) Patent Application Publication
(10) Pub. No.: US 2013/0150057 A1
(43) Pub. Date: Jun. 13, 2013

(54) METHOD OF ASSIGNING PHYSICAL LAYER CELL IDENTITY OF FEMTOCELL BASE STATION

(71) Applicants: Eun Seon CHO, Daejeon (KR); Byung Han RYU, Daejeon (KR); Nam Hoon PARK, Daejeon (KR); Chan Yong LEE, Daejeon (KR); Hyeon Ju OH, Daejeon (KR); Hong Soog KIM, Daejeon (KR)

(72) Inventors: Eun Seon CHO, Daejeon (KR); Byung Han RYU, Daejeon (KR); Nam Hoon PARK, Daejeon (KR); Chan Yong LEE, Daejeon (KR); Hyeon Ju OH, Daejeon (KR); Hong Soog KIM, Daejeon (KR)

(73) Assignee: Electronics and Telecommunications Research Institute, Daejeon (KR)

(21) Appl. No.: 13/461,119

(22) Filed: May 1, 2012

(30) Foreign Application Priority Data
Dec. 7, 2011 (KR) 10-2011-0130070

(51) Int. Cl. H04W 24/00; H04W 16/00

(52) U.S. Cl. 455/449; 455/456.5

(57) ABSTRACT

Provided is a method of assigning a physical layer cell identity (PCI) to a femtocell base station. The method includes obtaining location information from a femtocell base station and storing the location information, a first step of determining whether a PCI does not collide and is not confused with PCIs of base stations present in an area having a radius of a first multiple of a the femtocell radius and a second step of determining whether a PCI does not collide and is not confused with PCIs of base stations present in an area having a radius of a second multiple of the femtocell radius when a PCI does not collide and is not confused with PCIs of base stations is not found in an area having a radius of a first multiple of the femtocell radius.

### CLAIM FOR PRIORITY

This application claims priority to Korean Patent Application No. 10-2011-0130070 filed on Dec. 7, 2011 in the Korean Intellectual Property Office (KIPO), the entire contents of which are hereby incorporated by reference.

### BACKGROUND

1. Technical Field

Example embodiments of the present invention relate in general to a femtocell, and more particularly, to a method of assigning a physical layer cell identity (PCI), which is information for synchronization of user equipment (UE), to a home base station (femtocell base station) present in the coverage of a macrocell base station and installed in a house.

2. Related Art

As an identifier of a physical layer, a PCI of a base station is an indispensable configuration parameter of a radio cell.

UE identifies a cell using a PCI, which is a configuration parameter set upon initial installation of a base station. A PCI is a unique combination of one orthogonal sequence and one pseudorandom sequence. For example, in a Third Generation Partnership Project (3GPP) Long-Term Evolution (LTE) system, only 504, that is, a limited number of PCIs, are supported, and thus it is impossible to avoid reuse of a PCI, that is, the same PCI should be used for different cells.

A newly installed base station needs to select a PCI for its cell. At this time, PCI assignment needs to satisfy two conditions: “Collision-free” and “Confusion-free.”

In current 3GPP TR36.902 documents, “Collision-free” and “Confusion-free” have been defined.

“Collision-free” means that a PCI has a unique value in an area (coverage) covered by the corresponding cell, and “Confusion-free” means that a cell does not have the same PCI as neighboring cells.

Recently, a home base station, such as a femtocell, that is a personal base station installed indoors to serve one to four subscribers is being proposed. Such a femtocell base station is located in an area of an outdoor macro base station having a large radius. In an urban environment, there are a considerable number of femtocell base stations.

To distinguish between a cell of such a femtocell base station including a closed subscriber group (CSG) cell and a cell of a macro base station, a standard involving separately assigning a PCI space to a femtocell base station has been set. Thus, a PCI assignment method is needed to satisfy the conditions “Collision-free” and “Confusion-free” using a small number of PCIs for a femtocell base station.

### SUMMARY

Accordingly, example embodiments of the present invention are provided to substantially obviate one or more problems due to limitations and disadvantages of the related art.

Example embodiments of the present invention provide a method for a femtocell base station to set a physical layer cell identity (PCI) of the femtocell base station satisfying “Collision-free” and “Confusion-free” conditions in a mobile communication system.

Example embodiments of the present invention also provide a method for an operation and maintenance (O&M) server to assign a PCI to a femtocell base station in a mobile communication system in order to set a PCI satisfying “Collision-free” and “Confusion-free” conditions for the femtocell base station.

Example embodiments of the present invention also provide a method of setting a PCI to a femtocell base station in a mobile communication system in order to set a PCI satisfying “Collision-free” and “Confusion-free” conditions for the femtocell base station.

In some example embodiments, a method for a femtocell base station to set a PCI includes: obtaining, at the femtocell base station, its current location information; transmitting, at the femtocell base station, its current location information to an O&M server; receiving, at the femtocell base station, information on at least one assignable PCI based on its current location information from the O&M server; and setting, at the femtocell base station, its PCI on the basis of the information on the at least one PCI.

Here, obtaining the current location information may be performed through a satellite positioning device prepared in the femtocell base station or using the Institute of Electrical and Electronics Engineers (IEEE) 1588 protocol.

Here, the method may further include, after setting, at the femtocell base station, its PCI, notifying the O&M server of information on the set PCI.

In other example embodiments, a method of assigning a PCI to a femtocell base station in a mobile communication system includes: obtaining current location information on the femtocell base station from the femtocell base station; storing the obtained current location information; a first step of finding a PCI that does not collide and is not confused with PCIs of base stations present in an area having a radius of a first multiple of a cell radius of the femtocell base station; when a PCI that does not collide and is not confused with the PCIs is found in the first step, transmitting the at least one found PCI to the femtocell base station, and when no PCI that does not collide and is not confused with the PCIs is found in the first step, proceeding to a second step; the second step of, when no PCI that does not collide and is not confused with the PCIs is found in the first step, finding a PCI that does not collide and is not confused with PCIs of base stations present in an area having a radius of a second multiple of the cell radius of the femtocell base station; and when a PCI that does not collide and is not confused with the PCIs is found in the second step, transmitting the at least one found PCI to the femtocell base station, and when no PCI that does not collide and is not confused with the PCIs is found in the second step, performing the process again beginning with the first step.

Here, the first multiple may be a greater value than the second multiple.

Here, the cell radius of the femtocell base station may be an average cell radius of a plurality of femtocell base stations in the mobile communication system.

In other example embodiments, a method of setting a PCI to a femtocell base station present in a mobile communication system including at least one femtocell base station and an O&M server, includes: (a) obtaining, at the femtocell base station, its current location information; (b) transmitting, at the femtocell base station, the current location information to the O&M server; (c) generating, at the O&M server, information on at least one assignable PCI on the basis of the current location information on the femtocell base station and transmitting the information on the at least one assignable PCI to the femtocell base station; and (d) setting, at the femtocell base station, its PCI on the basis of the information on the at least one assignable PCI received from the O&M server.

Here, (c) may include: storing the current location information obtained in (b); a first step of finding a PCI that does not collide and is not confused with PCIs of base stations present in an area having a radius of a first multiple of a cell radius of the femtocell base station; when a PCI that does not collide and is not confused with the PCIs is found in the first step, transmitting the at least one found PCI to the femtocell base station, and when no PCI that does not collide and is not confused with the PCIs is found in the first step, proceeding to a second step; the second step of, when no PCI that does not collide and is not confused with the PCIs is found in the first step, finding a PCI that does not collide and is not confused with PCIs of base stations present in an area having a radius of a second multiple of the cell radius of the femtocell base station; and when a PCI that does not collide and is not confused with the PCIs is found in the second step, transmitting the at least one found PCI to the femtocell base station, and when no PCI that does not collide and is not confused with the PCIs is found in the second step, performing the process again beginning with the first step.

Here, the first multiple may be a greater value than the second multiple.

Here, the cell radius of the femtocell base station may be an average cell radius of a plurality of femtocell base stations in the mobile communication system.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating a method of assigning a physical layer cell identity (PCI) of a femtocell base station according to an example embodiment of the present invention in a mobile communication system in which a macro base station is installed with a plurality of femtocell base stations;

FIG. 2 is a conceptual diagram illustrating a method of assigning a PCI on the basis of a location of a femtocell base station according to an example embodiment of the present invention;

FIG. 3 is a flowchart illustrating a method of assigning a PCI to a femtocell base station in a mobile communication system according to an example embodiment of the present invention;

FIG. 4 is a flowchart illustrating a method for an operation and maintenance (O&M) server to assign a PCI to a femtocell base station according to an example embodiment of the present invention;

FIG. 5 is a flowchart illustrating a first step of a method for an O&M server to assign a PCI to a femtocell base station according to an example embodiment of the present invention; and

FIG. 6 is a flowchart illustrating a second step of a method for an O&M server to assign a PCI to a femtocell base station according to an example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

The term “user equipment (UE)” used herein may be referred to as a mobile station (MS), user terminal (UT), wireless terminal, access terminal (AT), terminal, subscriber unit, subscriber station (SS), wireless device, wireless communication device, wireless transmit/receive unit (WTRU), mobile node, mobile, or other terms. Various example embodiments of UE may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or UE having a combination of such functions, but are not limited to these.

The term “base station” used herein generally denotes a fixed or moving point communicating with UE, and may be referred to as a Node-B, evolved Node-B (eNB), base transceiver system (BTS), access point (AP), relay, femtocell, and other terms. In particular, the term “base station” is also used as the term “femtocell base station,” which means a base station installed in an office and having a small cell coverage with low output power.

Hereinafter, example embodiments of the present invention will be described in detail with reference to the appended drawings. To facilitate understating the present invention, like numbers refer to like elements throughout the description of the drawings, and the description of the same component will not be reiterated.

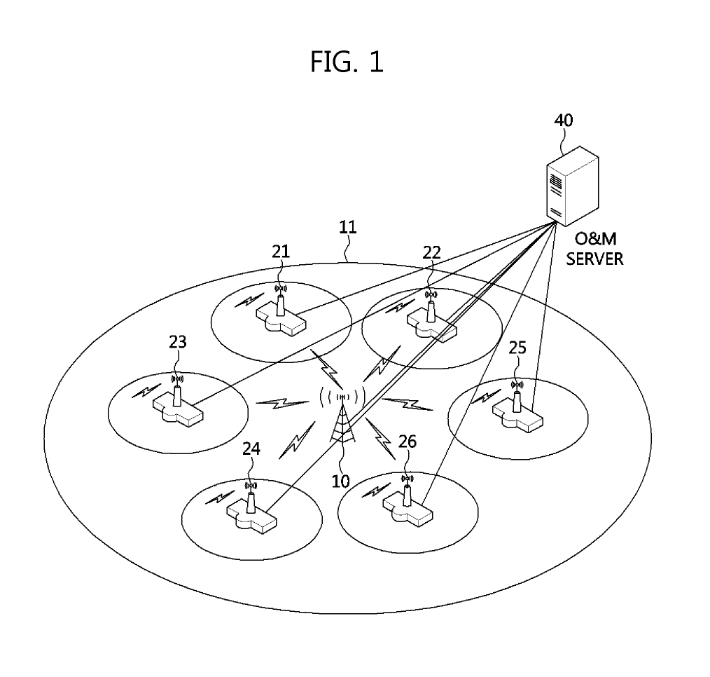

FIG. 1 is a conceptual diagram illustrating a method of assigning a physical layer cell identity (PCI) of a femtocell base station according to an example embodiment of the present invention in a mobile communication system in which a macro base station is installed with a plurality of femtocell base stations.

Referring to FIG. 1, a plurality of femtocell base stations 21 to 26 are in a coverage 11 of a macrocell base station 10, and the respective base stations receive configuration information from an operation and maintenance (O&M) server 40 and perform configuration.

Unlike a macro base station, a femtocell base station is installed in a house and may be turned on or off according to a user's intention. When the power of a femtocell base station is turned on or a user instructs reconfiguration of the femtocell base station, the femtocell base station needs to interoperate with the O&M server 40 and be assigned a new PCI. This PCI needs to be assigned within a PCI range assigned to the femtocell. In a Third Generation Partnership Project (3GPP) Long-Term Evolution (LTE) system, there are a total of 504 PCIs. Excluding the number of PCIs assigned to macrocells, there are only a small number of PCIs, which need to be reused and satisfy two conditions: “Collision-free” and “Confusion-free.”

In other words, when power is applied to a femtocell base station, the femtocell base station performs an automatic configuration setting process by connecting with the O&M server 40. During the automatic configuration setting process, an operation of setting configuration information for the femtocell base station to enter an operating state for service is performed.

At this time, in an example embodiment of the present invention, the femtocell base station performs a process of transmitting its location information to the O&M server 40, receiving an assigned PCI from the O&M server 40, and setting the assigned PCI as its PCI, and the O&M server 40 performs a process of assigning the PCI on the basis of the location information received from the femtocell base station. Meanwhile, after setting its PCI, the femtocell base station may notify the O&M server 40 of information on the set PCI. The O&M server 40 stores and manages the information on the PCI assigned to the femtocell base station with the received location information as a database, and later processes PCI assignment requests from other femtocell base stations with reference to the database.

The location information on the femtocell base station may be obtained through a satellite positioning device, such as a global positioning system (GPS) receiver, prepared in the femtocell base station, or using a protocol, such as Institute of Electrical and Electronics Engineers (IEEE) 1588.

A PCI assignment method according to an example embodiment of the present invention illustrated in the conceptual diagram of FIG. 1 will be separately described below in terms of operation of a femtocell base station, operation of an O&M server that performs PCI assignment for femtocell base stations, and overall operation of a mobile communication system.

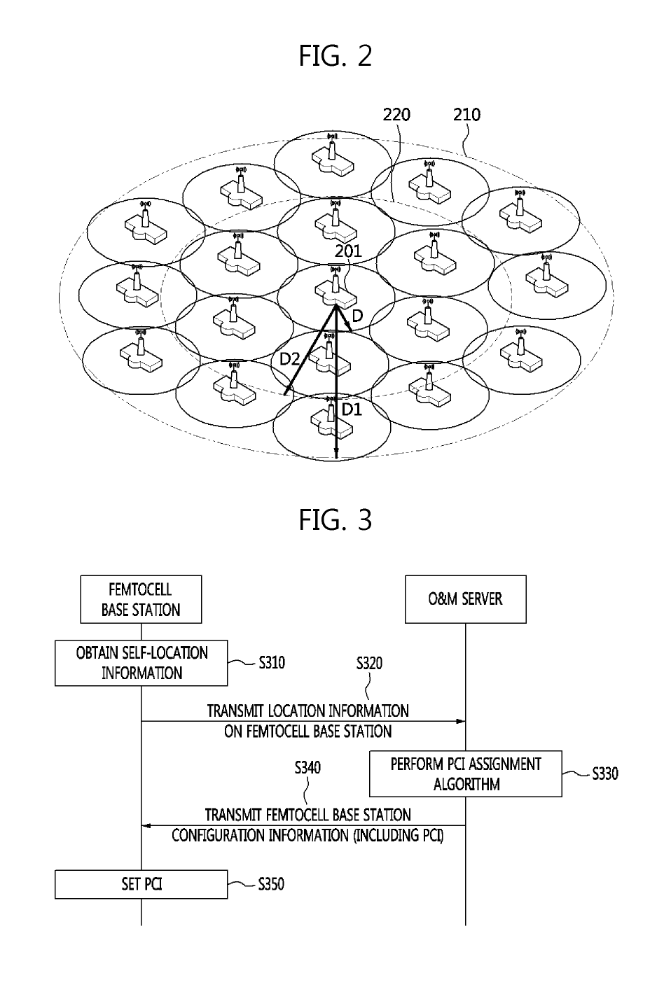

FIG. 2 is a conceptual diagram illustrating a method of assigning a PCI on the basis of a location of a femtocell base station according to an example embodiment of the present invention.

Referring to FIG. 2, in an example embodiment of the present invention, a first step range 210 and a second step range 220 for PCI assignment are set on the basis of a location of a femtocell base station 201 to be assigned a PCI, and PCIs of nearby femtocell base stations in the ranges are not allowed to be used, so that collision- and confusion-free PCI assignment can be performed.

In other words, a first PCI assignment step is intended to assign a collision- and confusion-free PCI in consideration of even adjacent cells of adjacent cells of the corresponding femtocell base station present in a larger area compared to a second PCI assignment step, and when no assignable PCI is found in the first PCI assignment step, the coverage is reduced to include only the adjacent cells of the femtocell base station in a second PCI assignment step, thereby assigning an available PCI.

Since an assignable PCI is searched for in a wide range area and then a narrow range area based on the coverage of the femtocell base station by stages, it is possible to disperse PCIs assigned to femtocell base stations over the wide range area and also reduce PCI collisions.

FIG. 3 is a flowchart illustrating a method of assigning a PCI to a femtocell base station in a mobile communication system according to an example embodiment of the present invention.

Referring to FIG. 3, a method of assigning a PCI to a femtocell base station in a mobile communication system according to an example embodiment of the present invention is a method of setting a PCI of a femtocell base station in a mobile communication system including at least one femtocell base station and O&M server, and may include: obtaining, at the femtocell base station, its current location information (S310); transmitting, at the femtocell base station, the current location information to the O&M server (S320); generating, at the O&M server, information on at least one assignable PCI on the basis of the current location information on the femtocell base station (S330); transmitting, at the O&M server, the information on the at least one assignable PCI to the femtocell base station (S340); and setting, at the femtocell base station, its PCI on the basis of the information on the at least one assignable PCI received from the O&M server (S350).

Since a femtocell base station is installed in each house and may be turned on or off according to a user's intention, the femtocell base station obtains its current location information (S310) when the power of the femtocell base station is turned on or the user instructs reconfiguration of the femtocell base station. At this time, the location information on the femtocell base station may be obtained through positioning equipment, such as a GPS receiver, prepared in the femtocell base station, or using a protocol, such as IEEE1588.

Next, the femtocell base station transmits the obtained current location information to an O&M server (S320). At this time, the current location information may be included in a registration message for the O&M server of the femtocell base station and transmitted, so that the process of transmitting the current location information can be performed.

When the location information on the femtocell base station is received from the femtocell base station, the O&M server stores the location of the femtocell base station included in the message, and performs a step of assigning a PCI of the femtocell base station (S330). Subsequently, the O&M server performs a step of transmitting femtocell base station configuration information including generated information on an assignable PCI to the femtocell base station (S340). The location of the femtocell base station is stored because location information on femtocell base stations managed by the O&M server needs to be used to assign PCIs to other femtocell base stations.

The femtocell base station sets its PCI on the basis of the assignable PCI information received from the O&M server (S350).

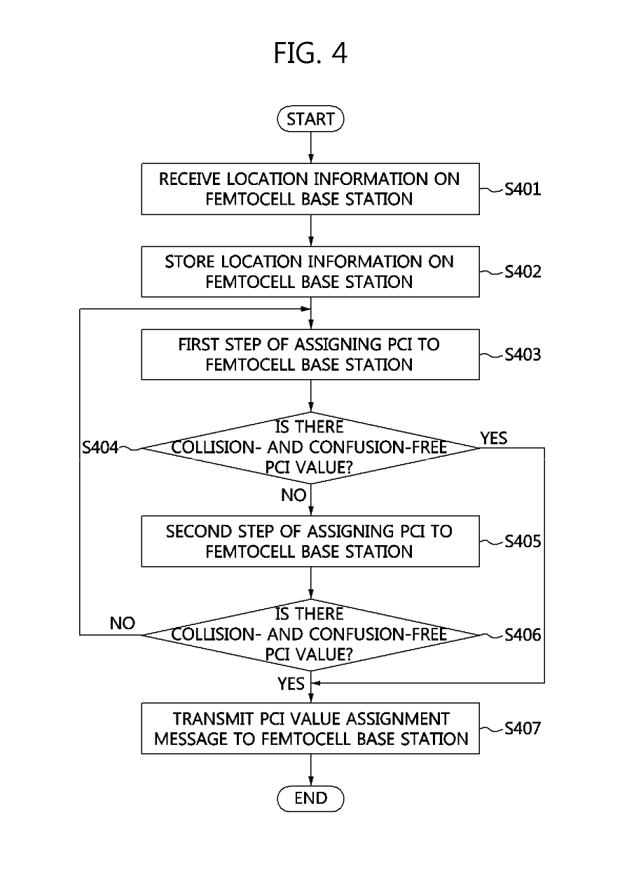

Meanwhile, the PCI assignment step (S330) and the transmission step (S340) performed by the O&M server will be described in detail below through steps 5402 to 5407 with reference to FIGS. 4 to 6.

FIG. 4 is a flowchart illustrating a method for an O&M server to assign a PCI to a femtocell base station according to an example embodiment of the present invention.

Referring to FIG. 4, a method for an O&M server to assign a PCI to a femtocell base station according to an example embodiment of the present invention may include: obtaining current location information on a femtocell base station from the femtocell base station (S401); storing the obtained current location information (S402); a first step of finding a PCI that does not collide and is not confused with PCIs of base stations present in an area having a radius of a first multiple of a cell radius of the femtocell base station on the basis of the cell radius of the femtocell base station (S403); determining in the first step whether a PCI does not collide and is not confused with the PCIs, proceeding to a step of transmitting the at least one found PCI to the femtocell base station (S407) when a PCI does not collide and is not confused with the PCIs, and proceeding to a second step when there is no PCI that does not collide and is not confused with the PCIs (S404); the second step of, when it is determined in the first step that there is no PCI that does not collide and is not confused with the PCIs, finding a PCI that does not collide and is not confused with PCIs of base stations present in an area having a radius of a second multiple of the cell radius of the femtocell base station (S405); and proceeding to the step of transmitting the at least one found PCI to the femtocell base station (S407) when a PCI that does not collide and is not confused with the PCIs is found in the second step, and performing the process again beginning with the first step when no PCI that does not collide and is not confused with the PCIs is found in the second step (S406).

In other words, when location information is received from a femtocell base station, the O&M server stores the location of the femtocell base station and performs the first step of assigning a PCI of the femtocell base station.

When there is a collision- and confusion-free PCI value in the first step of assigning a PCI of the femtocell base station, the O&M server transmits the PCI value to the femtocell base station, thereby assigning the PCI value. When there is no collision- and confusion-free PCI value, the O&M server performs the second step of assigning a PCI of the femtocell base station.

When there is a collision- and confusion-free PCI value in the second step of assigning a PCI of the femtocell base station, the O&M server transmits the PCI value to the femtocell base station, thereby assigning the PCI value. When there is no collision- and confusion-free PCI value, the O&M server performs the process again beginning with the first step of assigning a PCI of the femtocell base station (S403).

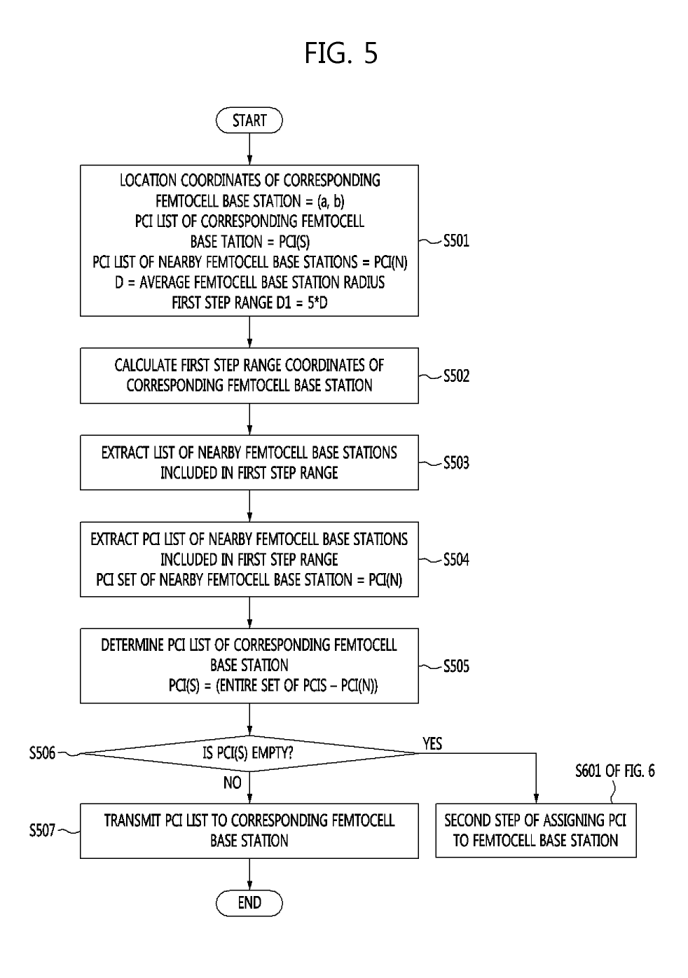

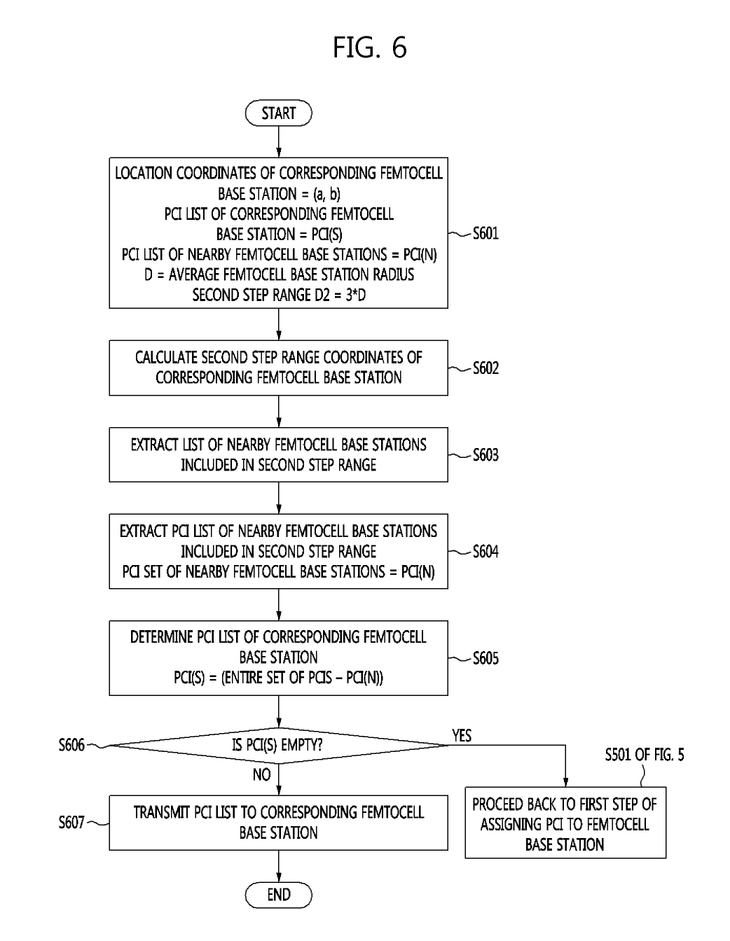

A process including the first and second steps of assigning a PCI of the femtocell base station (S403 to 5407) described with reference to FIG. 4 will be described in detail below with reference to FIGS. 5 and 6.

In FIGS. 5 and 6, a list of PCIs assignable to the corresponding femtocell base station to be assigned a PCI is denoted by PCI(S), and a list of PCIs having been already assigned to femtocell base stations (i.e., femtocell base stations included in first and second step ranges) around the femtocell base station to be assigned a PCI is denoted by PCI(N).

FIG. 5 is a flowchart illustrating a first step of a method for an O&M server to assign a PCI to a femtocell base station according to an example embodiment of the present invention.

Referring to FIGS. 3 and 5, when D denotes an average cell radius of femtocell base stations, a first step range for assigning a PCI of the femtocell base station is determined to be five times D (S501). Here, the first step range is determined to be five times D by way of example only, and may be another value.

The first step range for PCI assignment is calculated on the basis of location information on the femtocell base station (S502), and a list of nearby femtocell base stations present in the first step range is extracted (S503). Also, a list PCI(N) of PCIs having been already assigned to the nearby femtocell base stations is extracted (S504). A list of PCIs for the femtocell base station, that is, PCI(S), is determined by removing PCI(N) from an entire set of PCIs assigned to all femtocell base stations in the system (S505).

Here, it is determined whether an assignable PCI is included in the determined list PCI(S) (S506). When no assignable PCI is included, the process proceeds to a second step (S601), and when at least one assignable PCI is included, the PCI list (i.e., PCI(S)) is transmitted to the femtocell base station (S507).

FIG. 6 is a flowchart illustrating a second step of a method for an O&M server to assign a PCI to a femtocell base station according to an example embodiment of the present invention.

Referring to FIGS. 3 and 6, when D denotes an average cell radius of femtocell base stations, a second step range for assigning a PCI of the femtocell base station is determined to be three times D (S601). Here, the second step range is determined to be three times D by way of example only, and may be another value.

The second step range for PCI assignment is calculated (S602), and a list of nearby femtocell base stations present in the second step range is extracted (S6503). Also, a list PCI(N) of PCIs having been already assigned to the nearby femtocell base stations is extracted (S604). A list PCI(S) of PCIs for the femtocell base station is determined by removing PCI(N) from the entire set of PCIs assigned to all of the femtocell base stations in the system (S605).

Here, it is determined whether an assignable PCI is included in the determined list PCI(S) (S606). When no assignable PCI is included, the process proceeds back to the first step (S501), and when at least one assignable PCI is included, the PCI list (i.e., PCI(S)) is transmitted to the femtocell base station (S607). Since a femtocell base station is personally used, its power is frequently turned on and off. Thus, after a predetermined time elapses from an initial first PCI assignment step, a new assignable PCI may be found. For this reason, the process proceeds back to the first step (S501) when no assignable PCI is included. However, the femtocell base station may be configured to show an error message indicating that PCI assignment is impossible to a user when no assignable PCI is found even after the first and second PCI assignment steps are repeated several time.

In the above-described methods of assigning a PCI to a femtocell base station according to example embodiments of the present invention, it is possible to assign a PCI of a femtocell base station while satisfying the conditions “Collision-free” and “Confusion-free” using location information on the femtocell base station.

While the example embodiments of the present invention and their advantages have been described in detail, it should be understood that various changes, substitutions and alterations may be made herein without departing from the scope of the invention.

What is claimed is:

1. A method for a femtocell base station to set a physical layer cell identity (PCI), comprising:
obtaining, at the femtocell base station, its current location information;
transmitting, at the femtocell base station, its current location information to an operation & maintenance (O&M) server;
receiving, at the femtocell base station, information on at least one assignable PCI based on its current location information from the O&M server; and
setting, at the femtocell base station, its PCI on the basis of the information on the at least one PCI.

2. The method of claim 1, wherein obtaining the current location information is performed through a satellite positioning device prepared in the femtocell base station.

3. The method of claim 1, further comprising, after setting, at the femtocell base station, its PCI, notifying the O&M server of information on the set PCI.

4. A method of assigning a physical layer cell identity (PCI) to a femtocell base station in a mobile communication system, the method comprising:
obtaining current location information on the femtocell base station from the femtocell base station;
storing the obtained current location information;
a first step of finding a PCI that does not collide and is not confused with PCIs of base stations present in an area having a radius of a first multiple of a cell radius of the femtocell base station;
when a PCI that does not collide and is not confused with the PCIs is found in the first step, transmitting the at least one found PCI to the femtocell base station, and when no PCI that does not collide and is not confused with the PCIs is found in the first step, proceeding to a second step;
the second step of, when no PCI that does not collide and is not confused with the PCIs is found in the first step, finding a PCI that does not collide and is not confused with PCIs of base stations present in an area having a radius of a second multiple of the cell radius of the femtocell base station; and
when a PCI that does not collide and is not confused with the PCIs is found in the second step, transmitting the at least one found PCI to the femtocell base station, and when no PCI that does not collide and is not confused with the PCIs is found in the second step, performing the process again beginning with the first step.

5. The method of claim 4, wherein the first multiple is a greater value than the second multiple.

6. The method of claim 4, wherein the current location information on the femtocell base station is obtained through a satellite positioning device prepared in the femtocell base station.

7. The method of claim 4, wherein the cell radius of the femtocell base station is an average cell radius of a plurality of femtocell base stations in the mobile communication system.

8. A method of setting a physical layer cell identity (PCI) to a femtocell base station present in a mobile communication system including at least one femtocell base station and an operation & maintenance (O&M) server, the method comprising:
(a) obtaining, at the femtocell base station, its current location information;
(b) transmitting, at the femtocell base station, the current location information to the O&M server;
(c) generating, at the O&M server, information on at least one assignable PCI on the basis of the current location information on the femtocell base station and transmitting the information on the at least one assignable PCI to the femtocell base station; and
(d) setting, at the femtocell base station, its PCI on the basis of the information on the at least one assignable PCI received from the O&M server.

9. The method of claim 8, wherein (a) includes obtaining the current location information on the femtocell base station through a satellite positioning device prepared in the femtocell base station.

10. The method of claim 8, wherein (c) includes:
storing the current location information obtained in (b);
a first step of finding a PCI that does not collide and is not confused with PCIs of base stations present in an area having a radius of a first multiple of a cell radius of the femtocell base station;
when a PCI that does not collide and is not confused with the PCIs is found in the first step, transmitting the at least one found PCI to the femtocell base station, and when no PCI that does not collide and is not confused with the PCIs is found in the first step, proceeding to a second step;
the second step of, when no PCI that does not collide and is not confused with the PCIs is found in the first step, finding a PCI that does not collide and is not confused with PCIs of base stations present in an area having a radius of a second multiple of the cell radius of the femtocell base station; and
when a PCI that does not collide and is not confused with the PCIs is found in the second step, transmitting the at least one found PCI to the femtocell base station, and when no PCI that does not collide and is not confused with the PCIs is found in the second step, performing the process again beginning with the first step.

11. The method of claim 10, wherein the first multiple is a greater value than the second multiple.

12. The method of claim 10, wherein the cell radius of the femtocell base station is an average cell radius of a plurality of femtocell base stations in the mobile communication system.
